(19) United States
(12) Patent Application Publication
(10) Pub. No.: US 2026/0024064 A1
(43) Pub. Date: Jan. 22, 2026

(54) DATA TRACKING AND TRANSFERS

(71) Applicant: MASTERCARD INTERNATIONAL INCORPORATED, Purchase, NY (US)

(72) Inventors: Derek Vismantas, Jersey City, NJ (US); James Michael Snapp, Butler, PA (US); James Chernesky, Larchmont, NY (US); Suk Yin Gigi Lai, New York, NY (US); Wilder Correa-Muñoz, Bayonne, NJ (US)

(21) Appl. No.: 18/776,873

(22) Filed: Jul. 18, 2024

(51) Int. Cl. G06Q 20/10; G06Q 20/40

(52) U.S. Cl. CPC G06Q 20/10; G06Q 20/4016

(57) ABSTRACT

A system on a payment network can facilitate a method including receiving a first request to transfer a first funding amount from a first financial institution to a second financial institution, the first request comprising a mapping indicator; requesting approval, from the first financial institution, of the first funding amount for the second financial institution; receiving the approval from the first financial institution; storing a first transaction record including the mapping indicator; receiving a second request to transfer the first funding amount from the second financial institution to a third financial institution, the second request comprising the mapping indicator; storing a second transaction record including the mapping indicator; and settling funds between the first financial institution and the payment network, the payment network and the second financial institution, the second financial institution and the payment network and the payment network and the third financial institution on the same day.

### BACKGROUND

A payment network involves a collection of systems that facilitate the communication and transfer of funds. Typically, a cardholder makes a purchase through a point of interaction (POI) device/point of sale (POS) terminal associated with a merchant. The POI/POS connects to the payment network, via an acquirer, to route and communicate transaction messages across the payment network to an issuer. Return messages, such as pre-authorization response messages and authorization response messages, from the issuer are routed and communicated back to the merchant. The funding for the transaction may require a movement of the funds across multiple institutions. This movement of funds between institutions occurs as part of a settlement process.

### BRIEF SUMMARY

Improved data tracking and transfers are provided. Systems and methods are described that enable a same day settlement across multiple financial institutions over a payment network. Advantageously, the described systems and methods can enable tracking of data related to movement of funds across the multiple financial institutions so that a complete accounting of movement of funds for a given transaction where there are multiple financial institutions involved in the settlement process can be identified.

A system on a payment network can facilitate a method including receiving a first request to transfer a first funding amount from a first financial institution to a second financial institution, the first request comprising a mapping indicator; in response to receiving the first request, requesting approval, from the first financial institution, of the first funding amount for the second financial institution; receiving the approval from the first financial institution; storing a first transaction record indicating the first financial institution, the first funding amount, the second financial institution, and the mapping indicator; receiving a second request to transfer the first funding amount from the second financial institution to a third financial institution, the second request comprising the mapping indicator; in response to receiving the second request, storing a second transaction record indicating the second financial institution, the first funding amount, the third financial institution, and the mapping indicator; and settling funds between the first financial institution and a payment network, the payment network and the second financial institution, the second financial institution and the payment network and the payment network and the third financial institution on the same day.

In some cases, the method further includes providing, at the payment network, a plurality of application programming interfaces (APIs), including a funding API and a disbursement API. In some of such cases, receiving the first request is via the funding API and receiving the second request is via the disbursement API.

In some cases, where the first transaction record further indicates a first account at the first financial institution, the method can include receiving, at the payment network, a request for transaction records associated with the first account at the first financial institution; identifying transaction records associated with the first account at the first financial institution, including identifying transaction records indicating the first account at the first financial institution and transaction records having mapping indicators that match mapping indicators for those transaction records indicating the first account at the first financial institution; an generating a list of the identified transaction records that are associated with the first account at the first financial institution.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A illustrates an example operating environment for transaction settlement including improved data tracking and transfers.

FIG. 1B illustrates a process flow diagram for processing and settling transaction requests.

FIG. 2 illustrates an example method for facilitating and settling transaction requests performed at a system on a payment network.

FIG. 3 illustrates an example method of tracking transfers.

FIG. 4 illustrates a representative record of transfers for an example scenario described herein.

### DETAILED DESCRIPTION

Improved data tracking and transfers are provided. Systems and methods are described that enable settlement of proceeds of a funding transaction by moving funds from a funding sponsor institution to an originating institution and from the originating institution to a receiving institution on the same day via a payment network are described. Advantageously, the described systems and methods can enable tracking of data related to movement of funds so that a complete accounting of movement of funds for a given transaction can be identified.

An “originating institution” (OI) refers to a financial institution that provides funds transfer services to its customers and can be the entity that receives a first payment order initiation for a payment transaction. An originating institution can be an account holding institution.

An “account holding institution” (AHI) refers to a financial institution (e.g., a bank, savings association, credit union, or any other person) that directly or indirectly holds an account belonging to a consumer, or that issues an access device (e.g., bank card or credit card) and agrees with a consumer to provide electronic fund transfer services.

An “account” refers to an account, such as, but not limited to, a bank account or a payment card account, held directly or indirectly by a financial institution.

A “funding sponsor institution” refers to a financial institution that supports an originating institution in providing the funds granted by the originating institution to effect payment.

A “receiving institution” refers to a financial institution managing an account to which funds from an originating institution are to be ultimately sent. A receiving institution may be the institution holding the account (e.g., as an AHI) of a merchant receiving payment for goods or services sold to a customer having an account with an originating institution.

An “issuer” or “issuing bank” is the financial institution that issues a credit or debit card and enables funds to be released to a merchant's acquiring bank/receiving institution.

“Payment settlement”, “transaction settlement”, or “settlement” refers to the process of moving funds from a first cardholder's account to a second cardholder's account. “Payment settlement” can also refer to the process of moving funds from a cardholder's account to a merchant's account following a credit or debit card purchase. During settlement of a credit card purchase, an issuing bank routes funds to an acquirer via a payment network (through a payment gateway to the payment network). Settlement occurs after a transaction is cleared and processed. There is often a settlement interval—the amount of time that elapses between the trade date (T) (the date on which a trade/bargain is executed) and the settlement date(S). Typically, the settlement interval is T+2 or T+3.

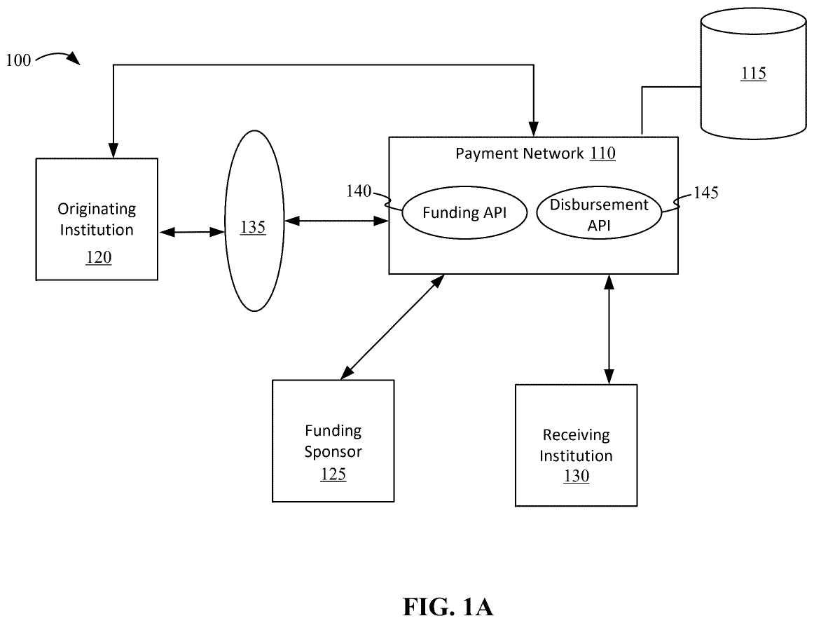

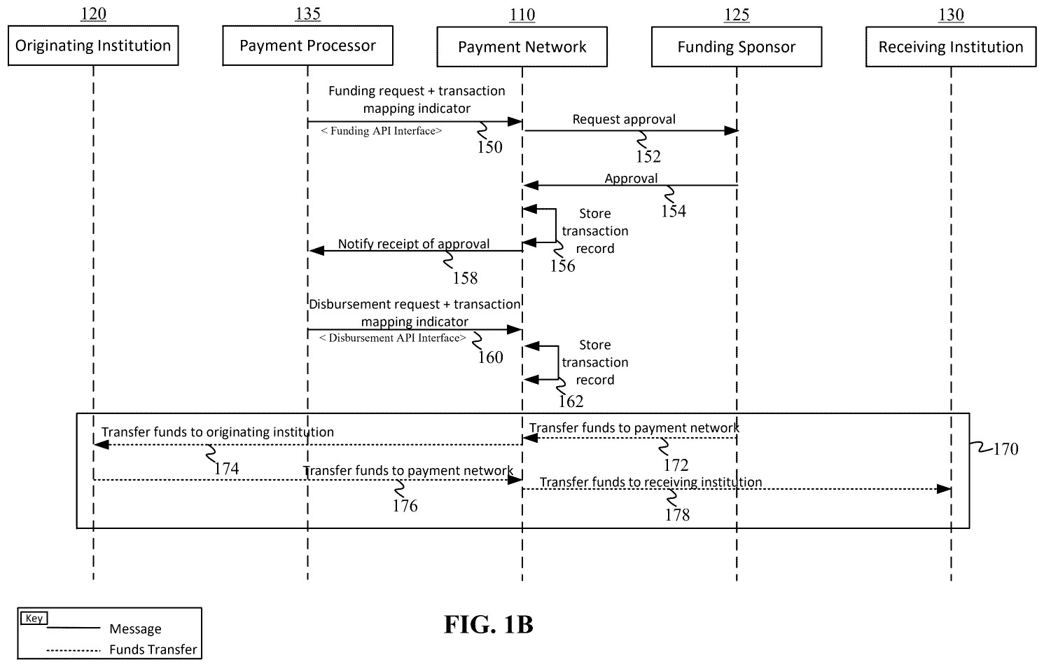

FIG. 1A illustrates an example operating environment for transaction settlement including improved data tracking and transfers; and FIG. 1B illustrates a process flow diagram for processing and settling transaction requests. Referring to FIG. 1A, operating environment 100 can include a payment network 110, an originating institution 120, a funding sponsor 125, a receiving institution 130, and a payment processor 135.

The payment network 110 can include systems providing a plurality of application processing interfaces (APIs) which can support the described improved data tracking and transfers. These systems can be considered part of or associated with the payment network 110. The APIs provided by payment network 110 can include a funding API 140 service for requesting funds and a disbursement API 145 service for disbursing funds to a receiving account. For example, when the payment network Mastercard payment network, the funding API 140 may be implemented, in part, using Mastercard® Send™ Funding API service, and the disbursement API 145 may be implemented, in part, using Mastercard® Send™ Disbursements API service.

An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

In some cases, the systems on the payment network 110 and one or more of the systems supporting the originating institution 120, funding sponsor 125, receiving institution 130, and payment processor 135 can communicate with ISO messages. An ISO message is a global standard for exchanging electronic messages between financial institutions.

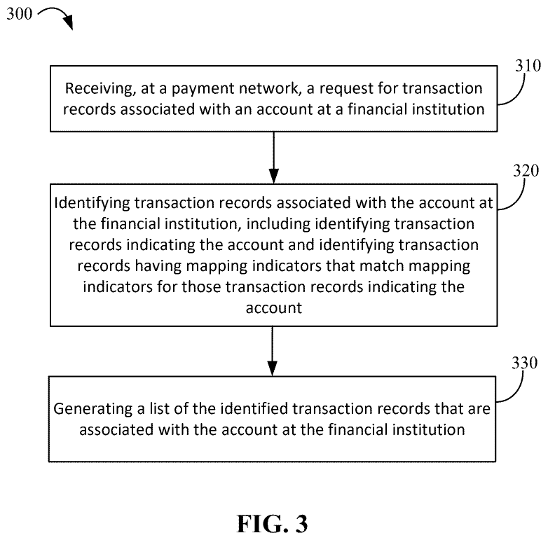

Payment network 110 further includes a storage resource 115 associated therewith that stores records associated with activities on the payment network 110. Storage resource 115 can be leveraged to support services such as described with respect to FIG. 3.

The originating institution 120 is an AHI that manages an account where a transfer of funds originates (e.g., an account holder at the originating institution 120 transfers funds to an account at the receiving institution 130). The receiving institution 130 is an AHI that manages an account designated to receive a transfer of funds (e.g., an account at the receiving institution 130 is the destination for funds sent from the originating institution 120). The funding sponsor 125 is a sponsor financial institution. In some cases, the funding sponsor 125 sponsors funding for some or all accounts at the originating institution 120. In some cases, a funding sponsor is a federal- or state-chartered bank, which is a member of one or more of the credit card associations and which processes credit and debit card transactions, facilitates the movement of money, and provides related services.

The payment processor 135 can be a vendor service that enables merchants, business owners, and individuals to accept payments from customers who are using payment methods other than cash or check. In some cases, the payment processor 135 is the same entity as an acquirer.

During completion and settlement processes, the payment processor 135 can facilitate the transfer of funds between different financial institutions (e.g., originating institution 120, funding sponsor 125, and receiving institution 130) through messages with systems on the payment network 110, for example, by use of the APIs provided by the payment network 110.

As such, the payment network 110 and its services can be used instead of the conventional settlement process (e.g., resolving bank transactions without a payment network, for example, via the Automated Clearing House (ACH) network). Advantageously, by using the payment network 110 and communications described herein (e.g., via API services), settlements between a plurality of financial institutions can be settled faster, and without the operational difficulties that are associated with conventional settlement.

Indeed, the payment network 110 can be used to process transactions as indicated by transaction requests received by the payment network 110 and facilitate settlement for the parties involved in each transaction, including ensuring that funds are transferred from an account at an originating institution 120 (that may be funded by a funding sponsor 125) to an account at a receiving institution in T+1 (i.e., the settlement date for the transaction is one day after the transaction date).

Turning to FIG. 1B, the process for completion and settlement of a transaction begins after the transaction has taken place. That is, the process shown in FIG. 1B occurs in place of the conventional internal settlement operations that move funds between financial institutions.

As mentioned above, in some cases, the originating institution 120 is sponsored by the funding sponsor 125. That is, funding sponsor 125 provides the actual funds used to send to the receiving institution 130. For example, the originating institution 120 may not have the funding required to fulfill the original transaction request from a customer account to a receiving account, and therefore, may need to obtain funding from the funding sponsor 125 to fulfill the request for a transfer of funds to the receiving account at the receiving institution 130.

Therefore, to facilitate the distribution of funds from the originating institution 120 to the receiving institution 130, the payment processor 135 may first request (via the funding API 140 of the payment network 110) the necessary funds from the funding sponsor 125. The payment processor 135 may keep a record of obligatory relationships between various financial institutions (e.g., funding sponsor 125 is the sponsor for originating institution 120), such that when the payment processor 135 goes to settle the transaction request between the originating account at the originating institution 120 and the receiving account at the receiving institution 130, the payment processor 135 is aware that it must first request to pull funds from the funding sponsor 125 to an account at the originating institution 120.

The payment network 110 thus receives (150), via a funding API (e.g., funding API 140), a funding request from the payment processor 135. In some cases, the payment network receives (150) the funding request from another entity facilitating completion of a transaction request (e.g., an acquiring bank on behalf of a merchant such as when the payment processor is separate from the acquirer or the receiving institution 130 on behalf of an account holder such as when the account holder initiated the funding process). The funding request requests that a specified funding amount be transferred from the funding sponsor 125 to an account at the originating institution 120 (e.g., the originating account). In some cases, the funding request is a transaction funding pull request.

The funding request includes a mapping indicator. In some cases, the mapping indicator is a unique identifier that is used to indicate that the funding request is part of a sequence of related activities on behalf of an originating institution. In some cases, the mapping indicator indicates that the requested transfer of funds from the funding sponsor 125 to the originating institution 120 is part of a funding completion transaction for a receiving institution 130. In some cases, the funding request received through the funding API also includes one or more of a funding amount, an originating account ID, an originating institution ID, a funding sponsor ID, a funding sponsor account ID, and a merchant identifier (ID) corresponding to a merchant associated with the transaction.

In response to receiving the funding request via the funding API, the payment network 110 can (e.g., as part of the funding API services) request (152) approval of the funding amount from the funding sponsor 125. In some cases, requesting (152) approval includes sending a message to the funding sponsor 125, where the message can include some or all of the information included in the funding request, for example, an originating institution ID, an originating account ID, the funding amount, etc.

The payment network receives (154) notice of approval from the funding sponsor 125. The payment network stores (156) a transaction record for the funding request, for example at storage resource 115 of FIG. 1A. In some cases, the payment network stores (156) the transaction record in response to receiving the funding request. In some cases, the payment network stores (156) the transaction record in response to receiving (154) approval from the funding sponsor 125. The transaction record indicates a mapping identifier associated with the mapping indicator, the funding amount, the funding sponsor 125, and the originating institution 120. In some cases, the transaction record includes a mapping identifier, a funding amount, a funding sponsor ID, a funding sponsor account ID, an originating institution ID, and an originating account ID. The mapping identifier may be the same string (e.g., alphanumeric string) as the mapping indicator included in the request or a string/identifier generated using or based on the mapping indicator.

In some cases, once the payment network receives (154) approval from the funding sponsor 125, the payment network can send (158) a notification to the payment processor 135 notifying the payment processor 135 that the funding transaction request has been approved by the funding sponsor 125.

The payment network 110 can receive (160), via a disbursement API (e.g., disbursement API 145), a disbursement request from the payment processor 135. In some cases, the payment network receives (160) the disbursement request from another entity facilitating completion of a transaction request (e.g., an acquiring bank on behalf of a merchant such as when the payment processor is separate from the acquirer). The disbursement request indicates a request to transfer funds from the originating account at the originating institution 120 to the receiving account at the receiving institution 130. In some cases, the disbursement request is a transaction disbursement push request.

Similar to the funding request, the disbursement request includes a mapping indicator. Advantageously, since the funding request and the disbursement request are sent by the payment processor 135 to fulfill a single transaction request (e.g., the transaction request requesting a transfer of funds from an originating account at the originating institution 120 to a receiving account at the receiving institution 130), the mapping indicator included with disbursement request can be the same mapping indicator that was included in the funding request. In some cases, the mapping indicator included in the funding request and the mapping indicator match (or otherwise correspond to) each other.

In some cases, the disbursement request can also include a funding amount, an originating account ID, an originating institution ID, a receiving institution ID, and a receiving account ID. In some cases, the disbursement request indicates a request to transfer the exact funding amount (e.g., the same funding amount as indicated in the funding request). However, in some cases, multiple disbursement requests may be utilized to transfer the funds from the originating account at the originating institution 120 to the receiving account at the receiving institution 130, and therefore, the disbursement request may indicate a different amount than the amount included in the funding request. In some of such cases, multiple disbursement requests may be made with funding amounts that together add up to the funding amount in the funding request.

In some cases, the payment processor 135 can send the disbursement request in response to receiving the notification that the funding request has been approved by the funding sponsor 125. However, advantageously, because the payment network 110 is responsible for facilitating the settlement, the payment processor 135 (and/or the originating institution 120) can be confident that the settlement process will be facilitated by the payment network 110 and that funding will be secured from the funding sponsor 125. Therefore, not only can the processor send a disbursement request before receiving settlement of funds from the funding sponsor 125, in some cases, the payment network 110 may receive (160) the disbursement request before a notification of approval is sent to the payment processor indicating the funding sponsor 125 approval. That is, the payment network 110 can receive (160) the disbursement request and receive (150) the funding request simultaneously or near simultaneously. Indeed, so long as a mapping indicator is included in the requests to indicate the linkage between the different requests, the order and timing of the two requests are not limited.

The payment network can store (162) a transaction record for the disbursement request. In some cases, the payment network can store (162) the transaction record in response to receiving the disbursement request. The transaction record indicates a mapping identifier associated with the mapping indicator, the funding amount, the originating institution 120, and the receiving institution 130. In some cases, the transaction record includes a mapping identifier, a funding amount, a funding sponsor ID, a funding sponsor account ID, an originating institution ID, and an originating account ID. As mentioned above, the mapping identifier may be the same string (e.g., alphanumeric string) as the mapping indicator included in the request or a string/identifier generated using or based on the mapping indicator.

Based on the requests received during a period of time (e.g., a period of a day or a certain number of hours), the payment network 110 can facilitate settlement 170 between the various financial institutions (e.g., funding sponsor 125, originating institution 120, and receiving institution 130) involved in the transaction request, in accordance with the received funding request and the received disbursement request. In some cases, the payment network 110 can facilitate settlement at the end of a business day. As illustrated in FIG. 1B, settlement 170 can include the funding sponsor 125 transferring (172) funds to the payment network 110, the payment network 110 transferring (174) funds to the originating institution 120, the originating institution 120 transferring (176) funds to the payment network 110, and the payment network 110 transferring (178) funds to the receiving institution 130.

It should be understood that each transfer of funds facilitated by the payment network 110 during settlement 170 can be completed simultaneously or sequentially. Advantageously, because the payment network 110 is responsible for settling each of the required funds transfers, all of the transfers required to complete the transaction request (e.g., transferring funds from the originating account at the originating institution 120 to the receiving account at the receiving institution) are settled on the same day and can be settled in T+1 days.

In some cases, the described functionality of the API calls (e.g., funding request and disbursement request) can instead be achieved using ISO messages. For example, the ISO message can also include a transaction mapping indicator. As an illustrative example, the payment network 110 may receive (150) the funding request from the payment processor 135 as an ISO message that includes the transaction mapping indicator.

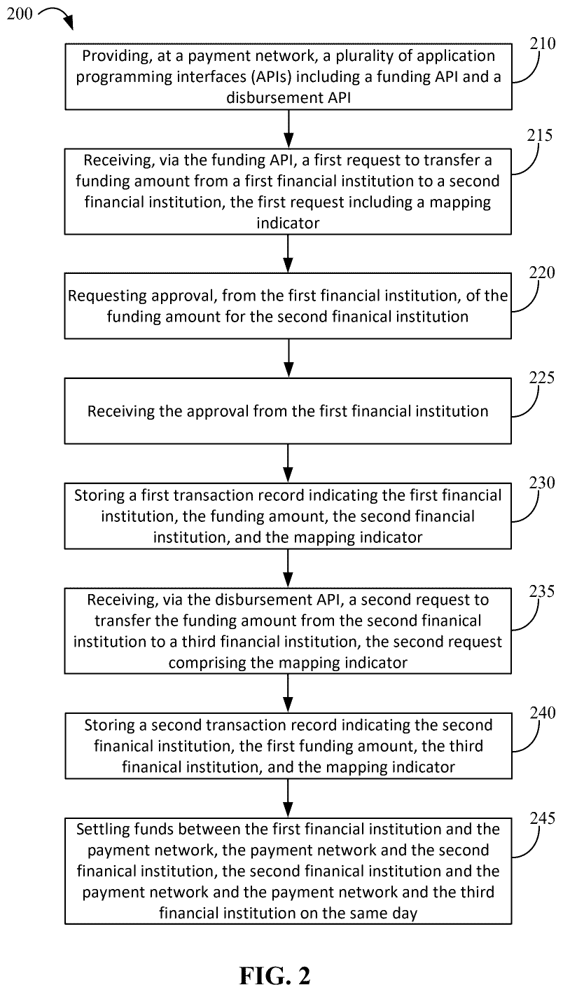

Advantageously, as described herein (e.g., as described above with respect to payment network 110 and when performing method 200 described with respect to FIG. 2), the payment network 110 can facilitate transaction settlement while removing a number of operational issues associated with internal settlement of proceeds of a funding transaction (e.g., a transaction initiated via a debit card, a credit card, a prepaid card, etc.) by moving funds from the funding sponsor 125 to the originating institution 120 and from the originating institution 120 to the receiving institution 130 on the same day. In contrast, conventionally, an originating institution (e.g., originating institution 120) moves money via ACH or other means (e.g., wires) to each depository institution.

That is, conventionally, an originating financial institution moves money via ACH or other means (e.g., wires) to each receiving financial institution. However, when multiple financial institutions are involved in a transaction, the settlement process can be time-consuming. For example, if an originating financial institution requires funding from a funding sponsor financial institution in order to have the necessary funds to ultimately transfer funds to an account at a receiving institution, the settlement and clearance of the funds sent from the sponsor financial institution must occur before the originating institution is able to send the requested funds to the receiving institution. Indeed, using conventional processes, transferred funds must be settled and cleared at each financial institution before they can be moved sequentially through the chain of financial institutions that may be required to complete a transfer of funds.

This process can be tedious and delays the receiving account from ultimately receiving the funds in a timely manner.

Therefore, there is a need for a more efficient funding and settlement process between an originating institution and a receiving institution, such that the funds transfers required for a transaction to fully settle all occur on the same day.

The described method enables faster internal settlement for registered participants through use of the payment network 110 and the provided APIs.

As such, using the systems and methods described herein, the payment network 110 can facilitate the processing and settlement of a large volume of transactions daily.

However, this extensive volume of transactions can make it difficult for the payment network to thoroughly and efficiently monitor the extensive number of transaction records for potential nefarious activity that may be occurring at the payment network 110.

One concern for the financial industry is money laundering. Money laundering generally refers to financial transactions in which criminals attempt to disguise the proceeds, sources, or nature of their illicit activities. Many criminals utilize various money laundering techniques, which can be carried out via services provided by the payment network 110. The payment network 110 is obligated to take up best practices to avoid and stop instances of criminal activity, including money laundering, that are perpetuated via the payment network 110.

Anti-money laundering practices are particularly important for payment networks, where payment networks facilitate millions of transactions every day and are constantly facilitating the movement of funds between various accounts at various financial institutions. For numerous reasons it can be important for payment networks to support legitimate transfer of funds while minimizing fraudulent or criminal use of the payment networks.

However, the sheer volume of transactions that are facilitated at the payment network can make detecting and stopping nefarious activity at the payment network difficult. This problem is exacerbated where the payment network may not be able to accurately track the entire scope of the movement of particular funds, especially when funds are moved between multiple financial institutions (e.g., perceived to the payment network as separate transaction requests) to facilitate a single transaction.

As such, without complete information, it can be difficult for the payment network to compile and store transaction history for accounts and financial institutions in a comprehensive manner that would allow the payment networks to most effectively combat money laundering and to comply with investigation requests and various compliance guidelines. Therefore, there is a need for comprehensive tracking and storage of complete transaction records that accurately indicate the parties involved in the transaction, and the associations between transactions, so that the payment network, and other requesting entities, have a complete and holistic accounting for the movement of funds across the payment network.

For example, one money laundering technique, known as “smurfing” or “structuring,” is a money laundering technique where illegal funds are divided into smaller amounts and deposited into multiple bank accounts or financial institutions. This allows criminals to circumvent financial regulations requiring banks to report large transactions. Once funds are successfully deposited, the funds are often transferred into other accounts or mingled with legitimate funds to further obscure the origin.

One of the tools to combat smurfing, and many other forms of money laundering, is monitoring transaction records and utilizing advanced algorithms to identify patterns or signs of suspicious activity. Because the payment network 110 can be utilized to facilitate such a large volume of settlements between numerous accounts at a variety of financial institutions, the payment network 110 can be particularly vulnerable to nefarious activity. However, the payment network 110 is also in a unique position to generate useful data (e.g., transaction records) for monitoring and detecting suspicious activity since the payment network 110 has such vast visibility and data for such a large number of transactions.

In order to effectively monitor the transaction records and the funds that flow through the payment network 110, it is beneficial to have a complete view of the movement of funds across the network. For example, when analyzing and monitoring transactions for suspicious activity, it can be particularly useful to accurately identify the origin and the destination of particular funds. This can be challenging, from the perspective of the payment network 110, where the payment network 110 does not have full visibility as to the complete scope of certain transactions, such as those involving multiple financial institutions.

Advantageously, by providing the described APIs (or appropriate ISO message field) and including a mapping indicator described herein on messages received at the payment network 110 (e.g., funding requests and disbursement requests), the payment network 110 can identify and store complete transaction data, which can be utilized to perform anti-money laundering practices, such as pattern monitoring of transactions, accounts, and financial institutions (see e.g., method 300 of FIG. 3).

FIG. 2 illustrates an example method for facilitating and settling transaction requests performed at a system on a payment network. The illustrated method incorporates APIs; however, certain embodiments contemplate the use of ISO messages and inclusion of the described mapping indicator.

Referring to FIG. 2, method 200, performed by one or more computing systems on a payment network (e.g., payment network 110 of FIGS. 1A and 1B), can include providing (210), at the payment network, a plurality of application programming interfaces (APIs) including a funding API and a disbursement API; receiving (215), via the funding API, a first request to transfer a funding amount from a first financial institution to a second financial institution, the first request including a mapping indicator; in response to receiving (215) via the funding API the first request, requesting (220) approval, from the first financial institution, of the first funding amount for the second financial institution; receiving (225) approval from the first financial institution; storing (230) a first transaction record indicating the first financial institution, the first funding amount, the second financial institution, and the mapping indicator; receiving (235), via the disbursement API, a second request to transfer the first funding amount from the second financial institution to a third financial institution, the second request comprising the mapping indicator; in response to receiving (235), via the disbursement API, the second request, storing (240) a second transaction record indicating the second financial institution, the first funding amount, the third financial institution, and the mapping indicator; and settling (245) funds between the first financial institution and the payment network, the payment network and the second financial institution, the second financial institution and the payment network, and the payment network and the third financial institution on the same day.

Once records are stored with corresponding mapping indicators/mapping identifiers, a variety of tools can be provided to leverage the available information, including tools for tracking transfers of funds.

FIG. 3 illustrates an example method for tracking transfers.

Referring to FIG. 3, method 300, performed by one or more computing systems on a payment network (e.g., payment network 110 of FIGS. 1A and 1B), can include receiving (310), at the payment network, a request for transaction records associated with an account at a financial institution. For example, the account can be a particular cardholder's account at a financial institution (e.g., originating account at the originating institution 120 described with respect to FIGS. 1A-1B).

In some cases, receiving (310) a request for transaction records associated with an account at a financial institution may include receiving a single or multiple requests for a plurality of accounts at the financial institution.

In some cases, the request for transaction records may originate from an internal source at the payment network (e.g., administrative, security, information technology (IT), etc.). In some cases, the request for transaction records may originate from a regulatory agency (e.g., the Federal Reserve System, U.S. Securities and Exchange Commission (SEC), Consumer Financial Protection Bureau, etc.) or other local, state, or federal government enforcement agencies (e.g., Federal Bureau of Investigations, state law enforcement agencies, etc.) seeking information regarding a particular account and/or a particular financial institution.

In response to receiving (310) the request for transaction records associated with an account at a financial institution, the method 300 can include identifying (320) transaction records associated with the account at the financial institution, including transaction records indicating the account (e.g., those records that show payment to or from the account) and transaction records having mapping indicators that match mapping indicators for those transaction records indicating the account (e.g., those records that do not include the account, but rather include a mapping indicator that matches a mapping indicator on a transaction that does include the account).

In some cases, the records considered associated with the account (i.e., both the transactions that include the account's identifier and the transactions that do not include the account's identifier but instead the same mapping indicator as any records that do include the account's identifier) are identified after receiving the request by first identifying transactions with the account identifier. Then, of those transactions with the account identifier, parsing or otherwise obtaining any mapping indicators from the transactions with the account identifier and searching the stored transactions for transactions that include the same mapping indicators as those from the transactions with the account identifier. The results of the search are included as part of the records considered to be associated with the account. The mapping indicators can be unique for each linked transaction chain. In some cases, the records considered to be associated with the account are identified at periodic intervals and stored in a manner that attaches them to the account (e.g., by including the account's identifier or some other identifier as part of the record) so that in response to the request, the records considered to be associated with the account are already grouped for the subsequent step.

In response to identifying (320) transaction records associated with the account at the financial institution, the method 300 can include generating (330) a list of the identified transaction records that are associated with the account at the financial institution. Advantageously, by utilizing the mapping indicators, the generated (330) list of identified transaction records is a comprehensive list of transaction records involving the account.

In some cases, method 300 can further include performing analysis of the generated list of the identified transaction records that are associated with the account at the financial institution to identify patterns of suspicious activity involving the account at the financial institution.

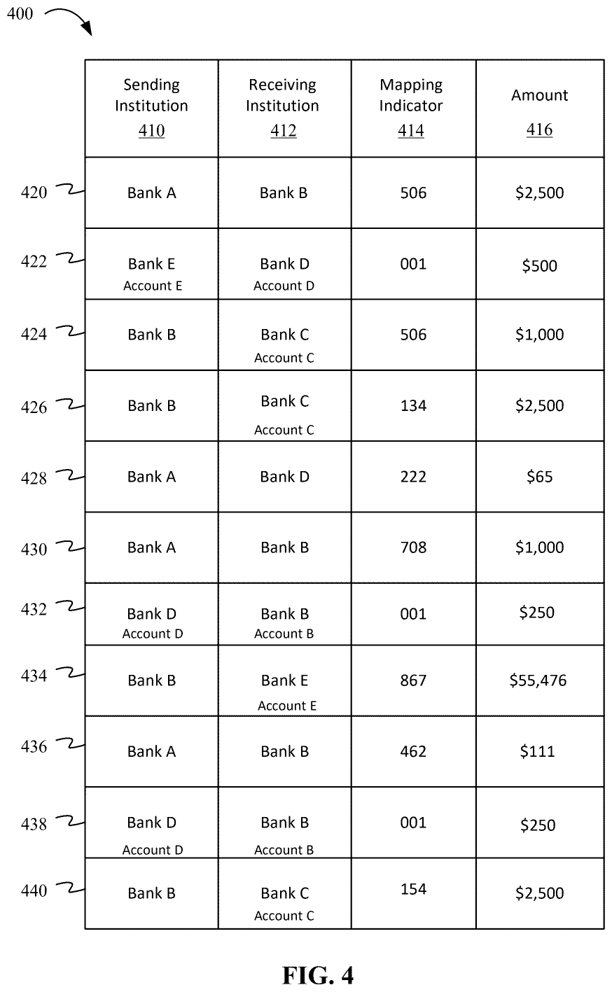

FIG. 4 illustrates a representative record of transfers for an example scenario described herein. As mentioned above, payment network (e.g., payment network 110 of FIGS. 1A-1B) can store records of transfers for a plurality of transactions that are processed at the payment network. It should be understood that the example data shown in FIG. 4 is provided for illustrative purposes and does not necessarily represent an actual data or data format as stored by the payment network. In addition, it should be noted that any transaction data stored by the payment network or associated systems conform to data privacy and protection regulations.

Referring to FIG. 4, an example transaction data structure 400 stored at the payment network can include a sending institution 410, a receiving institution 412, a mapping indicator 414, and a transaction amount 416 for each transaction record (e.g., transaction record 420, transaction record 422, transaction record 424, transaction record 426, transaction record 428, transaction record 430, transaction record 432, transaction record 434, transaction record 436, transaction record 438, and transaction record 440).

It should be understood that the data stored for each transaction record may include additional information, for example, a particular account at the sending institution 410 and a particular account at the receiving institution 412 (e.g., “Account: Customer C” as shown in transaction record 424, transaction record 426, and transaction record 440).

As described in detail above, by including mapping indicators 414, it is possible to more clearly trace the flow of funds over the payment network.

For example, following method 300 of FIG. 3, let's assume that the payment network has received (310) a request for transaction records associated with Customer C's account at a Bank C, for example, from a regulatory agency wishing to monitor Customer C's cash flow for suspicious patterns.

In response to receiving (310) the request for transactions associated with Customer C's account, the payment network can identify (320) transaction records associated with Customer C's account at Bank C. Identifying (320) transaction records associated with Customer C's account includes identifying transaction records that indicate Customer C's account (e.g., transaction records 424, 426, and 440). Identifying (320) transaction records associated with Customer C's account also includes identifying transaction records having mapping indicators 414 that match mapping indicators 414 for those transaction records indicating Customer C's account. For example, in this case, transaction record 424, which is a transaction record indicating Customer C's account, has “506” as the mapping indicator 414.

Transaction records that have a matching “506” mapping indicator 414 will also be identified at the identifying (320) step. Transaction record 420 is a transaction record having a “506” mapping indicator 414 that matches the “506” mapping indicator 414 for a transaction record 424 indicating Customer A's account. Therefore, the payment network would identify (320) transaction records 420, 424, 426, and 440 as transaction records associated with Customer C's account at Bank C.

Note that the other transaction records indicating Customer C's account at Bank C (e.g., transaction record 426 and transaction record 440 have mapping indicators 414 that do not match the mapping indicator 414 for any other transaction records shown in the illustrative data structure 400. However, any other transaction records having a matching mapping indicator 414 would also have been identified at the identifying (320) step. In addition, not all records will have mapping indicators.

Advantageously, by utilizing the systems and methods described herein, mapping indicators included in the transaction messages received at the payment network (e.g., funding request and disbursement request) refine the accuracy of the transaction records kept by the payment network and provide for the ability to comprehensively track the movement of funds across the payment network. Therefore, the payment network is able to rely on complete transaction records to comply with outside agency requests, internally monitor transaction records for potential patterns and signs of suspicious activity and perform additional actions that can enhance the security of the payment network.

In some cases, it may be possible for the payment network to make an assumption as to the relationship between transaction record 420 and transaction record 424 without the mapping indicator, for example, based on the identical amount 416 of the transaction “$2,500,” along with other factors, such as recognition at the payment network of a sponsor relationship between Bank A and Bank B.

However, this scenario requires a lot of assumptions on the part of the payment network and is not infallible, likely leading to far more holes in the complete transaction landscape for a given financial institution than would be useful for combatting money laundering and other nefarious uses of the payment network services.

As an additional example, take the “001” mapping indicator 414 that is associated with transaction record 422, transaction record 432, and transaction record 438. Let's assume that Bank E is a sponsor institution for Bank D, and Customer D, having an account at Bank D wishes to send $500 to Customer B, having an account at Bank B.

Because Bank D is sponsored by Bank E, in processing the transaction request on behalf of Customer D, a funding request may be sent to the payment network requesting $500 funding for Customer D's account at Bank D from Bank E, as illustrated by transaction record 422. Subsequently, a disbursement request may be sent to the payment network requesting that $500 (via two, separate payments of $250) be transferred from Customer D's account at Bank D to Customer B's account at Bank B. For any number of reasons, this transaction may have been split into two transfers of $250 via the payment network, which are illustrated by transaction record 432 and transaction record 438.

From the payment network perspective, without the information provided by mapping indicator 414, the data for transaction record 422 indicates that Bank E sent $500 to Customer D's account at Bank D, and the payment network's visibility on the movement of that $500 would stop Customer D's account at Bank D. Indeed, there is nothing to associate transaction record 432 and transaction record 438 to transaction record 422, where Bank E is not indicated in transaction record 432 or transaction record 438.

However, this would be an incomplete record of the movement of the $500 funding. The $500 was only transferred to Bank D from Bank E as funding for the transfer of a total of $500 from Customer D's account at Bank D to Customer B's account at Bank B (e.g., transaction record 432 and transaction record 438). Therefore, the comprehensive record of the movement of the $500 would include transaction record 422, transaction record 432, and transaction record 438.

The following is an additional illustrative example of method 300 and assumes that the payment network has received (310) a request for transaction records associated with an account at Bank E (e.g., an account at Bank E that provided the $500 funding for Bank D as illustrated in transaction record 422). In this scenario, identifying (320) transaction records associated with the account at Bank E includes identifying transaction records indicating the account (e.g., transaction record 422 and transaction record 434) and transaction records having mapping indicators that match mapping indicators for those transaction records indicating the account (e.g., transaction records having a matching “001” mapping indicator 414, including transaction record 432 and transaction record 438). Then, the payment network can generate (330) a list of the identified transaction records that are associated with the account at Bank E, the list including transaction record 422, transaction record 434, transaction record 432, and transaction record 438.

Advantageously, the inclusion of a mapping indicator 414 (e.g., “506” and “001”) improves the payment network's ability to track the movement of funds across the payment network and allows the payment network to create and store comprehensive and detailed transaction records that can be utilized by the payment network, or outside organizations, to prevent and detect money laundering and other nefarious activity at the payment network.

In addition, the small payments of $250 each of transaction record 432 and transaction record 438 may not raise suspicion on their own, or trigger any auditing process, whereas transaction record 434 may automatically be flagged, since the transaction amount 416 of “$55,476” is over a particular threshold for review. However, as discussed herein, sophisticated money laundering schemes account for these thresholds and often attempt to disperse funds at lower amounts between various financial institutions. Therefore, it is advantageous for the payment network to be able to obtain a more complete record of the flow of funds between various financial institutions, so that pattern recognition and other techniques can be utilized to detect nefarious actions that could otherwise go unnoticed for transactions with smaller totals.

Embodiments of the described systems and methods may be implemented as a computer process, a computing system, or as an article of manufacture, such as a computer program product or computer-readable medium. Certain methods and processes described herein can be embodied as software, code and/or data, which may be stored on one or more storage media that when executed by one or more processor direct the system to perform the methods and processes described herein. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system (and executable by a processing system/one or more processors) and encoding a computer program of instructions for executing a computer process. It should be understood that as used herein, in no case do the terms “storage media,” “computer-readable storage media” or “computer-readable storage medium” consist of transitory carrier waves or propagating signals. Instead, “storage” media refers to non-transitory media.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method, comprising:
receiving, at a payment network, a first request to transfer a first funding amount from a first financial institution to a second financial institution, the first request comprising a mapping indicator;
in response to receiving the first request, requesting approval, from the first financial institution, of the first funding amount for the second financial institution;
receiving, at the payment network, the approval from the first financial institution;
storing a first transaction record indicating the first financial institution, the first funding amount, the second financial institution, and the mapping indicator;
receiving, at the payment network, a second request to transfer the first funding amount from the second financial institution to a third financial institution, the second request comprising the mapping indicator;
in response to receiving the second request, storing a second transaction record indicating the second financial institution, the first funding amount, the third financial institution, and the mapping indicator; and
settling funds related by the mapping indicator between the first financial institution and the payment network, the payment network and the second financial institution, the second financial institution and the payment network and the payment network and the third financial institution on a same day.

2. The method of claim 1, wherein the first transaction record further indicates a first account at the first financial institution and wherein the method further comprises:
receiving, at the payment network, a request for transaction records associated with the first account at the first financial institution;
identifying transaction records associated with the first account at the first financial institution, including identifying 1) transaction records indicating the first account at the first financial institution and 2) transaction records having mapping indicators that match mapping indicators for those transaction records indicating the first account at the first financial institution; and
generating a list of the identified transaction records that are associated with the first account at the first financial institution.

3. The method of claim 2, wherein the list of identified transaction records comprises the first transaction record and the second transaction record.

4. The method of claim 2, further comprising:
performing analysis of the list of the identified transaction records that are associated with the first account at the first financial institution to identify patterns of suspicious activity.

5. The method of claim 1, wherein the first request is a transaction funding pull request.

6. The method of claim 1, wherein the second request is a transaction disbursement push request.

7. The method of claim 1, further comprising sending notice of the approval from the first financial institution to a source of the first request.

8. The method of claim 1, wherein the first request comprises a first account identifier at the first financial institution and a second account identifier at the second financial institution.

9. The method of claim 1, further comprising:
providing, at a payment network, a plurality of application programming interfaces (APIs), including a funding API and a disbursement API;
wherein the first request is received via the funding API and the second request is received via the disbursement API.

10. The method of claim 1, wherein the first request comprises a first ISO message and the second request comprises a second ISO message.

11. A system, comprising:
one or more processors;
at least one storage system; and
instructions stored on the at least one storage system that when executed by the one or more processors, direct the system to:
provide a plurality of application programming interfaces (APIs), including a funding API and a disbursement API;
receive, via the funding API, a first request to transfer a first funding amount from a first financial institution to a second financial institution, the first request comprising a mapping indicator;
in response to receiving via the funding API the first request, request approval, from the first financial institution, of the first funding amount for the second financial institution;
receive the approval from the first financial institution;
store a first transaction record indicating the first financial institution, the first funding amount, the second financial institution, and the mapping indicator;
receive, via the disbursement API, a second request to transfer the first funding amount from the second financial institution to a third financial institution, the second request comprising the mapping indicator;
in response to receiving, via the disbursement API, the second request, store a second transaction record indicating the second financial institution, the first funding amount, the third financial institution, and the mapping indicator; and
settle funds between the first financial institution and a payment network, the payment network and the second financial institution, the second financial institution and the payment network and the payment network and the third financial institution on a same day.

12. The system of claim 11, wherein the first transaction record further indicates a first account at the first financial institution and wherein the instructions further direct the system to:
receive, at the payment network, a request for transaction records associated with the first account at the first financial institution;
identify transaction records associated with the first account at the first financial institution, including 1) transaction records indicating the first account at the first financial institution and 2) transaction records having mapping indicators that match mapping indicators for those transaction records indicating the first account at the first financial institution; and
generate a list of the identified transaction records that are associated with the first account at the first financial institution.

13. The system of claim 12, wherein the list of identified transaction records comprises the first transaction record and the second transaction record.

14. The system of claim 12, wherein the instructions further direct the system to perform analysis of the list of the identified transaction records that are associated with the first account at the first financial institution to identify patterns of suspicious activity.

15. The system of claim 11, wherein the first request is a transaction funding pull request.

16. The system of claim 11, wherein the second request is a transaction disbursement push request.

17. The system of claim 11, wherein the instructions further direct the system to send notice of the approval from the first financial institution to a source of the first request.

18. The system of claim 11, wherein the first request comprises a first account identifier at the first financial institution and a second account identifier at the second financial institution.

19. The system of claim 11, wherein the instructions further direct the system to:
provide, at a payment network, a plurality of application programming interfaces (APIs), including a funding API and a disbursement API;
wherein the first request is received via the funding API and the second request is received via the disbursement API.

20. The system of claim 11, wherein the first request comprises a first ISO message and the second request comprises a second ISO message.
